(19) United States
(12) Patent Application Publication
(10) Pub. No.: US 2005/0084446 A1
(43) Pub. Date: Apr. 21, 2005

(54) Zeolite synthesis with directing agents with approximately perpendicular groups

(76) Inventors: Kirk D. Schmitt, Pennington, NJ (US); Stephen G. Casmer, Bethlehem, PA (US)

Correspondence Address: EXXONMOBIL RESEARCH AND ENGINEERING COMPANY;(formerly Exxon Research and Engineering Company, P.O.Box 900, Annandale, NJ, 08801-0900, US

(21) Appl. No.: 10/958,708

(22) Filed: Oct. 5, 2004

Related U.S. Application Data
(60) Provisional application No. 60/512,584, filed on Oct. 17, 2003.

(51) Int. Cl. C01B 39/04

(52) U.S. Cl. 423/706; 423/708

(57) ABSTRACT

A new class of compounds that are particularly effective at directing the crystallization of useful zeolite materials.

### BACKGROUND OF THE INVENTION

This application claims the benefit of U.S. Provisional Application No. 60/512,584 filed Oct. 17, 2003.

The present invention relates to a process for preparing molecular sieve compositions including zeolites, in particular, the present invention relates to the directing agent for preparing the compositions.

Organic directing agents are currently selected either because they are easily derived from commercially available starting materials, or because molecular modeling of the external surface of the directing agent appears to be a good fit for a desired zeolite's pores or a poor fit for an undesired zeolite's pores or the directing agents may be selected simply because the chemist likes the look of the molecule. Directing agents may also be selected based on the C/N ratio or their hydrophile/lipophile balance.

The discovery of new or improved zeolites and the preparation of zeolites uncontaminated with other phases is an important step in discovering new catalysts and sorption agents for commercialization.

The discovery process may be carried out by a combinatorial approach in which known reagents and conditions are combined in many ways to test large numbers of reasonable conditions. This has been reported by Rollmann (Rollman, L. D.; Schlenker, J. L.; Lawton, S. L; Kennedy, G. J. J. Phys. Chem B 1999, 103, 7175-7183. “On the Role of Small Amines in Zeolite Synthesis.”) in which 30 commercially available amines were tested under a wide variety of synthetic conditions involving several thousand experiments. These experiments were tedious and time consuming and yielded no new zeolites. Many of the zeolites that were produced were impure phases. Such approaches may be viable for discovering new zeolites if suitable apparatus for rapidly carrying out thousands of experiments is available, for example, Newsam (Newsam, J. M.; Bein, T.; Klein, J.; Maier, W. F.; Stichert, W. Micropor. Mesopor. Mat. 2001, 48, 355-365. “High Throughput Experimentation for the Synthesis of New Crystalline Microporous Solids.”) has estimated that one new zeolite might be discovered for every 9000 experiments with this approach. An alternative is described by Zones (Wagner, P.; Nakagawa, Y.; Lee, G. S.; Davis, M. E.; Elomari, S.; Medrud, R. C.; Zones, S. I. J. Am. Chem. Soc. 2000, 122, 263-273. “Guest/Host Relationships in the Synthesis of the Novel Cage-Based Zeolites SSZ-35, SSZ-36, SSZ-39.”) “involves synthesizing rigid bulky organocations that are too large or of the wrong geometry to fit into the cavities or pores of commonly encountered competing phases such as the clathrates or the straight one-dimensional channel system zeolites.” This approach appears to have allowed the authors to discover three new or improved zeolites in fewer than 200 experiments. Thus, proper design can exclude unwanted zeolite phases.

In the present invention, it is found that the geometry of the directing agent described is particularly effective at avoiding the formation of common zeolites, clathrates, or uni-dimensional channel system zeolites without resorting to the use of “bulky” organocations.

### SUMMARY OF THE INVENTION

The present invention is a directing agent for directing the crystallization of molecular sieves, in particular, zeolite materials. Another aspect of the invention includes a process to prepare crystalline molecular sieve, in particular, zeolite materials.

The directing agent includes two intersecting planes that intersect at an angle between 65 and 115 degrees. In a preferred embodiment, the intersecting planes are defined by two groups C1-X1(R1)(R2)-C2 and C3-X2(R3, R4)-C4 wherein X1 and X2 are nitrogen or phosphorus in the same rings as C1-C2 and C3-C4, respectively. R1-R4 may be an electron lone pair, hydrogen or aliphatic or aromatic groups, and there are sufficient R1-R4 groups to satisfy the valence of X1 and X2, and R1-R4 are not in the same rings as C1-X1-C2 and C3-X2-C4. In another preferred embodiment, the planes are close to perpendicular. Placing the planes of the C1-X1-C2 and C3-X2-C4 groups approximately perpendicular has the advantage that 3-dimensional zeolite structures are more easily nucleated and the growth of easily nucleated and undesirable zeolites such as ZSM-5 or ZSM-12 is more easily inhibited.

### BRIEF DESCRIPTION OF THE DRAWINGS

FIG. 1 shows the powder X-ray diffraction patterns of calcined chabazite zeolites from Examples 5 and 6.

FIG. 2 shows the 360 MHz MAS Al-nmr of calcined chabazite materials from Examples 5 and 6. Peaks at 120 and −7 ppm are at the spinning side band spacing of 6.0 kHz so they may or may not represent other types of aluminum. Main peaks are at 58.2 ppm relative to aqueous Al(H₂O)₆³⁺. Expected shift for framework aluminum in chabazite at infinite magnetic field is calculated to be 59.4 ppm

FIG. 3 shows the SEM of calcined chabazite from Example 5.

FIG. 4 shows the SEM of calcined chabazite from Example 6.

FIG. 5 shows the 125 MHz C-nmr spectra of directing agent used in Example 5 and the material produced by dissolving the as-synthesized zeolite of Example 5 in HF/D₂O.

FIG. 6a shows the standard organic chemical drawing and as a 3-dimensional representation of the directing agent in Example 3.

FIG. 6b shows how the C-N-C groups (C1-X1-C2 and C3-X2-C4) define two planes and how these planes meet at an angle θ for the directing agent of Example 3.

### DETAILED DESCRIPTION OF THE PREFERRED EMBODIMENTS

The present invention includes a directing agent for molecular sieves and a process for preparing crystalline molecular sieves. Preferred molecular sieves are zeolites.

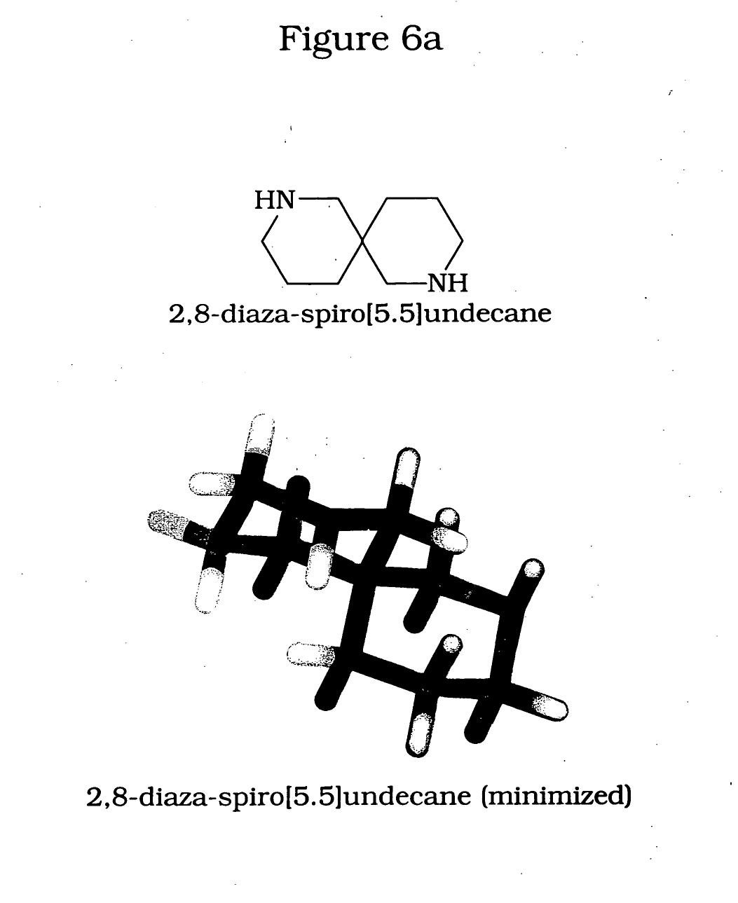

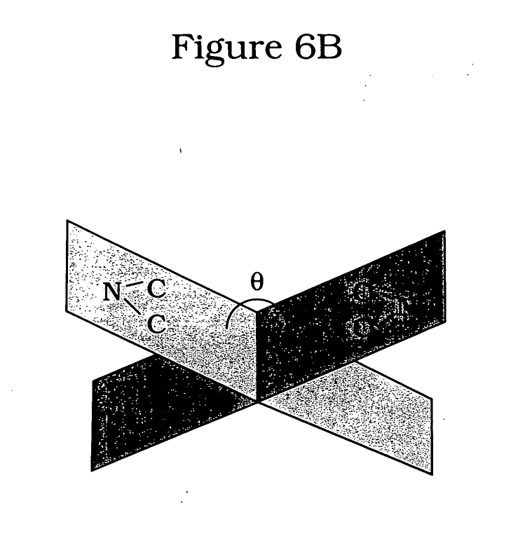

Preferred embodiments of directing agents include 2,8-diaza-spiro[5.5]undecane. In this compound X1=X2=N and R1=R3=H and R2=R4=lone pair. The detailed structure of this material is shown in FIG. 6A as a standard organic chemical drawing and as a 3-dimensional representation.

FIG. 6B shows how the C-N-C groups (C1-X1-C2 and C3-X2-C4) define two planes and how these planes meet at an angle, θ

The geometry of a molecule can be calculated to determine if it will fulfill the requirements of this invention using quantum mechanical or molecular mechanics programs supplied by various commercial vendors. For example, it is possible to carry out MM2 structure calculations using the commercial programs Chemdraw (CambridgeSoft) and ChemWindows (Bio-Rad Laboratories) and more sophisticated dynamics calculations using either the Materials Studio or Cerius2 programs (Accelrys Inc). These programs will generate the Cartesian coordinates of the C-X-C dihedrals.

If the normals, N₁ and N₂, of two planes are known, the angle between the planes can be determined from the dot-product of the normals,

$$θ = 180 - arccos \frac{{N}_{1} • {N}_{2}}{\vert {N}_{1} \vert \vert {N}_{2} \vert}$$

In algebraic terms, if the equations for the two planes are known, then the angle can be directly obtained.
a₁x+b₁y+c₁z+d₁=0
a₂x+b₂y+c₂z+d₂=0

$$θ = 180 - arccos \frac{\vert {a}_{1} {a}_{2} + {b}_{1} {b}_{2} + {c}_{1} {c}_{2} \vert}{\sqrt{{a}_{1}^{2} + {b}_{1}^{2} + {c}_{1}^{2}} \sqrt{{a}_{2}^{2} + {b}_{2}^{2} + {c}_{c}^{2}}}$$

The following table 1 illustrates several examples of compuonds, which meet the criteria for this invention.

TABLE 1

| Name | Compound | angle θ |
|---|---|---|
| 2,8-diaza-spiro[5.5]undecane | 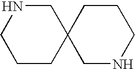 | 99 |
| 2,2,9,9-Tetramethyl-2,9-diazaonia- spiro[5.5]undecane | 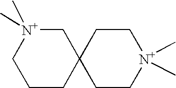 | 110 |
| 3,5,3′,5′-Tetramethyl-[4,4′]bipyridinyl | 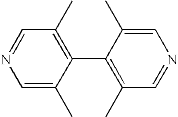 | 104 |
| 3,3′-Diisopropyl-[4,4′]bipyridinyl | 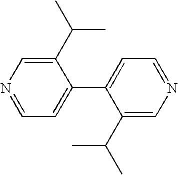 | 97 |
| “iso”-sparteine | 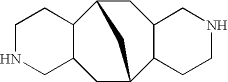 | 95 |

The examples illustrate the utility of this invention with 2,2,8,8-tetramethyl-2,8-diazonia-spiro[5.5]undecane as specific example of the directing agent. The synthesis of the directing agent may be described as follows.

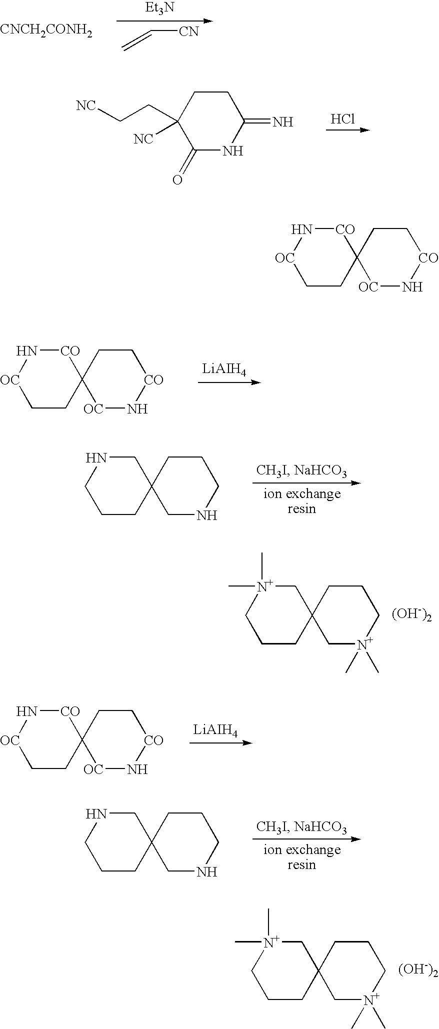

### EXAMPLE 1

### Synthesis of 3-(2-Cyano-ethyl)-6-imino-2-oxo-piperidine-3-carbonitrile

100.9 g cyanoacetamide were added to a 2 L Erlenmeyer containing 242 mL triethylamine, 384 mL H₂O, and 267 mL ethanol followed by 160 mL acrylonitrile. This mixture was stirred magnetically and the temperature gradually rose. At 45° C. all the solid had dissolved. The temperature reached a maximum of 59° C. and was allowed to cool back to 55° C. before heating to 60-70° C. on a steam bath for 2 hr. The mixture was allowed to cool to room temperature, filtered, washed with 800 mL isopropanol, sucked dry under a rubber dam and dried to constant weight in an 80-90° C. oven to yield 127 g yellow solid (56%).

The product had the expected ¹³C NMR spectrum. ¹³C NMR(d₆-DMSO): δ6174.3, 173.6, 119.8, 119.7, 42.1, 29.6, 27.1, 22.7, 12.7.

### EXAMPLE 2

### Synthesis of 2,8-Diaza-spiro[5.5]undecane-1,3,7,9-tetraone

To 127 g 3-(2-Cyano-ethyl)-6-imino-2-oxo-piperidine-3-carbonitrile in a 2 L Erlenmeyer flask were added 800 mL concentrated HCl. This mixture was heated in a steam bath to 90-95° C. at which point an exotherm took the temperature to about 105° C. and all the solid dissolved. After the temperature had dropped to 100° C., the mixture was heated 5 min with steam, then enough ice added to quickly reduce the temperature to <5° C. (About 2-3 mL crushed ice per 1 mL of HCl used). The product was filtered, washed with 1000 mL H₂O, sucked dry under a rubber dam, and dried to constant weight in an oven at 80 to 95° C. to yield 80.75 g (96%) white solid.

The product had the expected ¹³C NMR spectrum. ¹³C NMR(d₆-DMSO): δ172.5, 172.4, 49.1, 27.9, 25.5

### EXAMPLE 3

### Synthesis of 2,8-diaza-spiro[5.5]undecane

Forty-seven grams of 2,8-Diaza-spiro[5.5]undecane-1,3,7,9-tetraone were ground in a mortar and packed into a Soxhlet thimble. The packed thimble, Soxhlet extractor, a 2 L, 4-neck round-bottom flask equipped with mechanical stirrer, thermometer, and Friederich reflux condenser were dried 1 hr at 110° C. then assembled hot under flowing N₂ and cooled under N₂ supplied by a Firestone valve. A plastic bag containing 25 g LiAlH₄ pellets (10×13 mm, available from Aldrich) was attached to one joint using a cable tie, then the twister sealing the plastic bag removed and the pellets dumped into the flask. The plastic bag was removed and the joint fitted with a rubber septum and two 500 mL bottles of fresh, dry tetrahydrofuran were transferred to the flask using a double-ended cannula. The mixture was stirred and vigorously refluxed through the Soxhlet using a steam bath. All but about 3 g of the solid in the thimble dissolved within 20 hr of reflux. The flask was cooled in an ice bath, the Soxhlet extractor removed and an equalizing dropping funnel added, followed by 250 mL ether, and cautious dropwise addition of 25 mL H₂O, 25 g 15% NaOH, and 75 mL H₂O. The mixture was filtered, the solid washed well with ether, the solvent stripped, and the product Kugelrohr distilled to give 22.0 g (64%) water white oil, bp 110° C. @200 mTorr.

The product had the expected ¹³C NMR spectrum but also had an estimated 5% unknown impurities. ¹³C NMR(CDCl₃): δ54.6, 47.5, 34.2, 31.8, 22.3.

### EXAMPLE 4

### Synthesis of 2,2,8,8-tetramethyl-2,8-diazonia-spiro[5.5]undecane Hydroxide

To 9.8 g (64 mmol) 2,8-diaza-spiro[5.5]undecane and 10.7 g NaHCO₃ (127 mmol) in 250 mL MeOH were added 24 mL (380 mmol) MeI all at once. The mixture was stirred magnetically and refluxed. All the NaHCO₃ dissolved within 1 hr.

Reflux was continued until an aliquot diluted 2:1 with H₂O was no longer hazy and had a pH<8 (about 24 hr) at which point 125 mL solvent were distilled off and the mixture crystallized, first at room temperature, then in a freezer to give 21.2 g (72%) yellow needles.

The product had the expected ¹³C and ¹H NMR spectra and showed none of the impurities seen in the starting material. Attached proton counts were determined using the DEPT experiment. ¹³C NMR(D₂O): δ70.7(CH₂), 64.8(CH₂), 60.1(CH₃), 54.8(CH₃), 37.5(C_{q}), 31.9(CH₂) 19.2(CH₂). ¹H NMR(D₂O): δ3.53(1.97H, m), 3.43(1.98H, d), 3.35(2.3H, m), 3.24, 3.22, 3.20, (14.0H,s,s,m), 2.14(3.95H,m), 2.01(2.11H,m), 1.79(2.08H,m).

The iodide product was converted to the hydroxide salt by passing a solution of 70.0 g of the iodide in 1800 mL H₂O through 450 mL Dowex SBRLCNG OH resin at a rate of at least 50 mL/min. The resin was washed with 500 mL H₂O and the combined aqueous eluates stripped on a rotary evaporator in a bath at 45-50° C. to give 90.46 g solution (theoretical concentration=40.8% w/w). This solution was diluted and used to titrate potassium acid phthalate. Assuming the theoretical molecular weight and 2 equivalents per mole, the concentration by titration was found to be 41.2 and 40.4% in replicate analyses. The concentrated solution was diluted with an equal volume of 100 atom % D₂O and analyzed for organic by ¹H NMR by integration of the H₂O hydrogens versus the organic hydrogens. The concentration was found to be 37.8% w/w by NMR, so the material has been converted to the hydroxide in 100% yield within experimental error of the analyses.

### EXAMPLE 5

### Synthesis Conditions of Zeolite Directed by 2,2,8,8-2,8-diazonia-spiro[5.5]undecane Hydroxide

The conditions described in Table 2, which cover a very wide range of synthesis parameters, do not lead to any other mixtures of zeolites other than the material described in Example 6.

TABLE 2

| | | Ratio | | | | Ratio | | | | |
|---|---|---|---|---|---|---|---|---|---|---|
| | | (other | | Ratio | | (directing | Ratio | Ratio | Time | Temperature |
| Ratio (Si) | Si source | reagent) | Reagent | (Al) | Al source | agent) | (HF) | (H₂O) | (days) | (° C.) |
| 1 | Ludox | 0.12 | KOH | 0.1 | Al(OH)₃ | 0.1 | | 30 | 4-12 | 160 |
| | SM-30 | | | | | | | | | |
| 1 | Ludox | 0.12 | KOH | 0.042 | Al(OH)₃ | 0.1 | | 30 | 4-12 | 160 |
| | SM-30 | | | | | | | | | |
| 1 | Ludox | 0.12 | KOH | 0.017 | Al(OH)₃ | 0.1 | | 30 | 4-12 | 160 |
| | SM-30 | | | | | | | | | |
| 1 | Ludox | 0.12 | KOH | | | 0.1 | | 30 | 4-12 | 160 |
| | SM-30 | | | | | | | | | |
| 1 | Ludox | 0.12 | NaOH | 0.1 | Al(OH)₃ | 0.1 | | 30 | 4-12 | 160 |
| | SM-30 | | | | | | | | | |
| 1 | Ludox | 0.12 | NaOH | 0.042 | Al(OH)₃ | 0.1 | | 30 | 4-12 | 160 |
| | SM-30 | | | | | | | | | |
| 1 | Ludox | 0.12 | NaOH | 0.017 | Al(OH)₃ | 0.1 | | 30 | 4-12 | 160 |
| | SM-30 | | | | | | | | | |
| 1 | Ludox | 0.12 | NaOH | | | 0.1 | | 30 | 4-12 | 160 |
| | SM-30 | | | | | | | | | |
| 1 | Ludox | 0.14 | NaOH | 0.1 | sodium | 0.1 | | 40 | 4-12 | 160 |
| | SM-30 | | | | aluminate | | | | | |
| 1 | Ludox | 0.14 | NaOH | 0.042 | sodium | 0.1 | | 40 | 4-12 | 160 |
| | SM-30 | | | | aluminate | | | | | |
| 1 | Ludox | 0.14 | NaOH | 0.017 | sodium | 0.1 | | 40 | 4-12 | 160 |
| | SM-30 | | | | aluminate | | | | | |
| 1 | Ludox | | | 0.1 | Al | 0.17 | | 30 | 4-12 | 160 |
| | SM-30 | | | | | | | | | |
| 1 | Ludox | | | 0.042 | Al | 0.17 | | 30 | 4-12 | 160 |
| | SM-30 | | | | | | | | | |
| 1 | Ludox | | | 0.017 | Al | 0.17 | | 30 | 4-12 | 160 |
| | SM-30 | | | | | | | | | |
| 1 | Ludox | | | | | 0.155 | | 30 | 4-12 | 160 |
| | SM-30 | | | | | | | | | |
| 1 | UltraSil | | | | | 0.165 | 0.33 | 9 | 7-21 | 140 |
| | VN 3SP- | | | | | | | | | |
| | PM | | | | | | | | | |
| 1 | UltraSil | | | | | 0.135 | 0.27 | 5 | 7-21 | 140 |
| | VN 3SP- | | | | | | | | | |
| | PM | | | | | | | | | |
| 0.8 | UltraSil | 0.2 | GeO₂ | | | 0.165 | 0.33 | 7 | 7-21 | 140 |
| | VN 3SP- | | | | | | | | | |
| | PM | | | | | | | | | |
| 1 | UltraSil | | | 0.18 | Al | 0.225 | | 30 | 4-18 | 140 |
| | VN 3SP- | | | | | | | | | |
| | PM | | | | | | | | | |
| 1 | UltraSil | 0.05 | LiBr | 0.18 | Al | 0.225 | | 30 | 4-18 | 140 |
| | VN 3SP- | | | | | | | | | |
| | PM | | | | | | | | | |
| 1 | UltraSil | 0.08 | KBr | 0.18 | Al | 0.225 | | 30 | 4-18 | 140 |
| | VN 3SP- | | | | | | | | | |
| | PM | | | | | | | | | |
| 1 | UltraSil | | | 0.09 | Al | 0.225 | | 30 | 4-18 | 140 |
| | VN 3SP- | | | | | | | | | |
| | PM | | | | | | | | | |
| 1 | UltraSil | | | 0.03 | Al | 0.225 | | 30 | 4-18 | 140 |
| | VN 3SP- | | | | | | | | | |
| | PM | | | | | | | | | |
| 1 | UltraSil | | | 0.01 | Al | 0.225 | | 30 | 4-18 | 140 |
| | VN 3SP- | | | | | | | | | |
| | PM | | | | | | | | | |

### EXAMPLE 6

### Synthesis of Zeolite Directed by 2,2,8,8-tetramethyl-2,8-diazonia-spiro[5.5]undecane Hydroxide

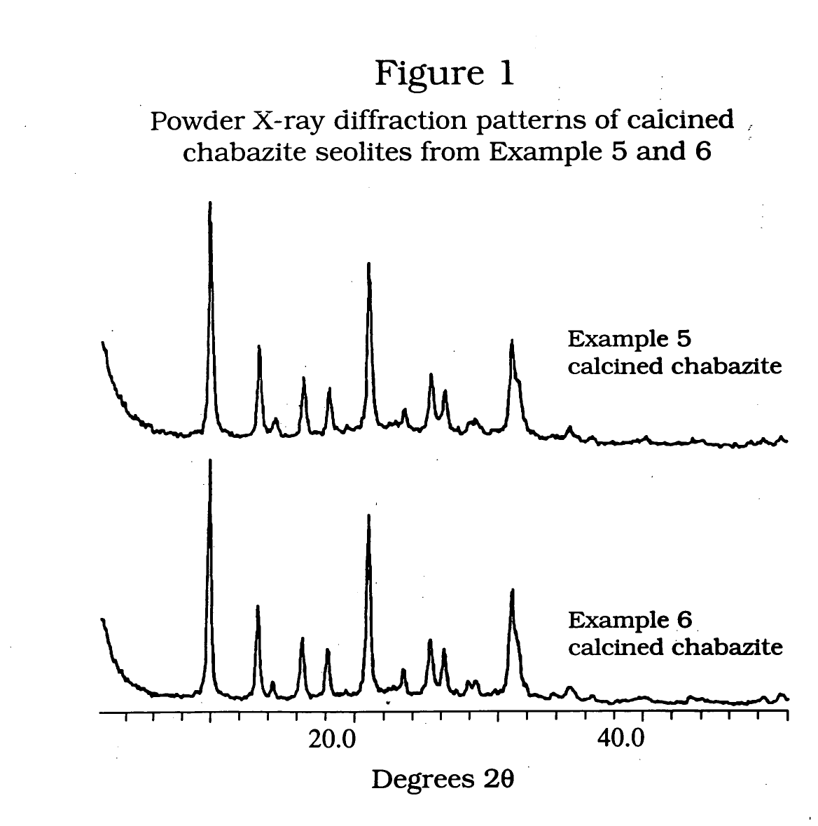

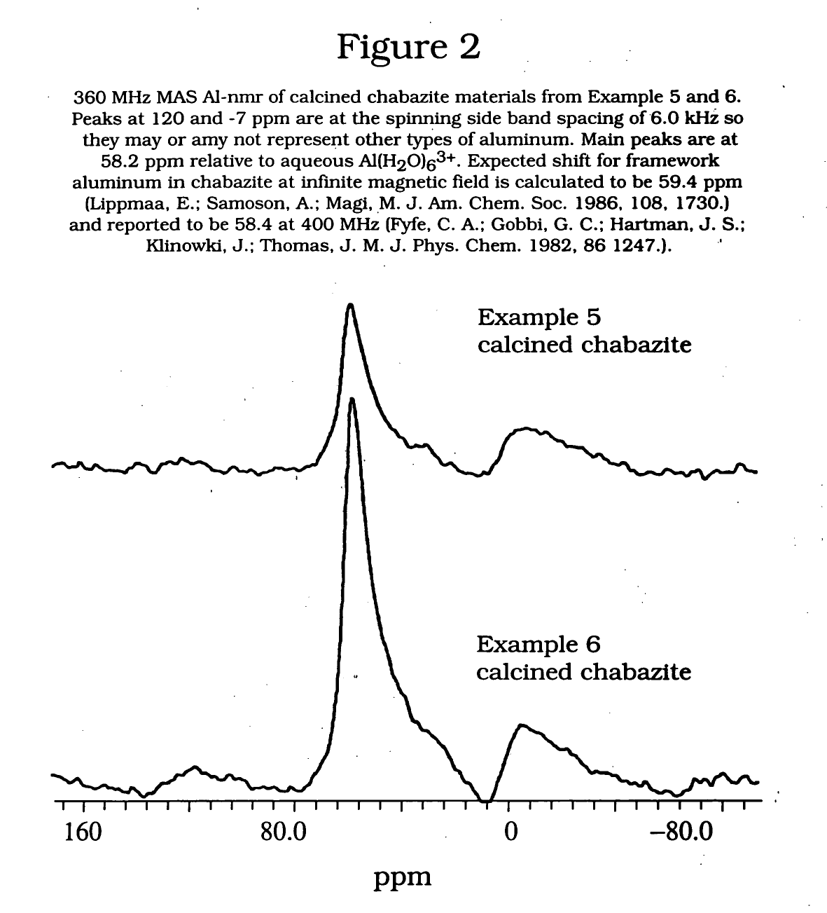

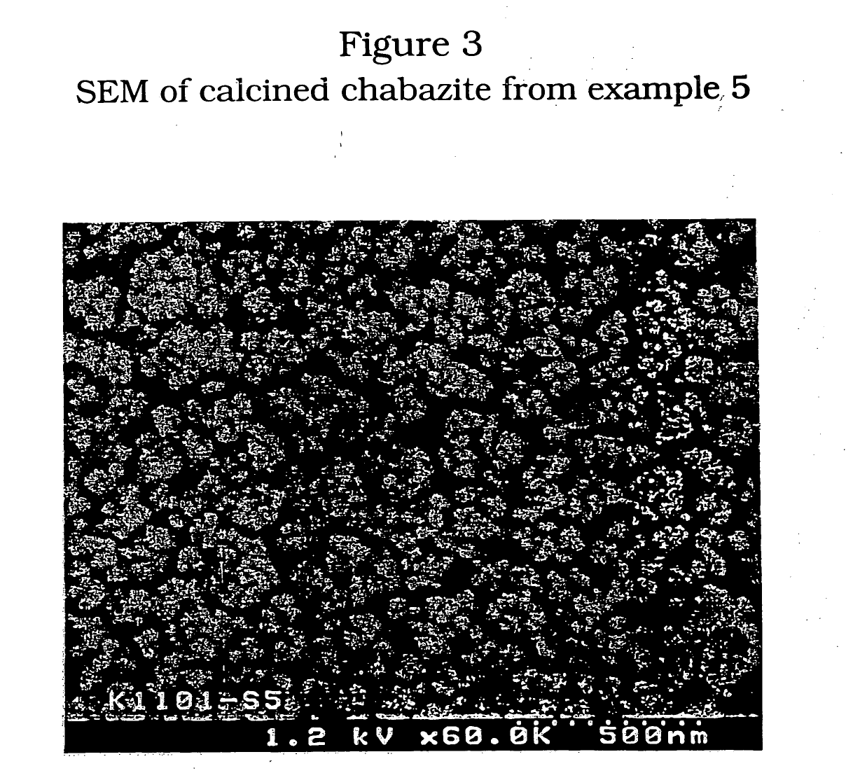

To 145.7 mg Al metal in a PFA bottle were added 4.17 g of the 37.8% solution of directing agent prepared in Example 4. After the Al metal had dissolved, 1.80 g silica (UltraSil VN 3SP-PM) and 13.7 g H₂O were added. The bottle was capped, shaken 48 hr at room temperature then heated 200 hr at 140° C. The product was isolated by filtration, washed with H₂O and dried to constant weight at 80° C. to give an off-white solid which was converted to organic-free zeolite by placing in an oven, ramping the temperature at 1° C./min to 540° C. under N₂, switching to dry air, holding 1 hr at 540° C., then cooling to room temperature under dry air. The yield of crystalline product was 1.36 g (76% based on silica). Powder X-ray diffraction shows the product to be pure, small crystal chabazite (FIG. 1). Quantitative Al-nmr shows the correct chemical shift for Al in the framework of chabazite and shows the Si/Al ratio to be 125/1 (FIG. 2). Scanning electron microscopy shows the product to be exceptionally small crystal material. (FIG. 3).

### EXAMPLE 7

### Synthesis of Zeolite Directed by 2,2,8,8-tetramethyl-2,8-diazonia-spiro[5.5]undecane Hydroxide

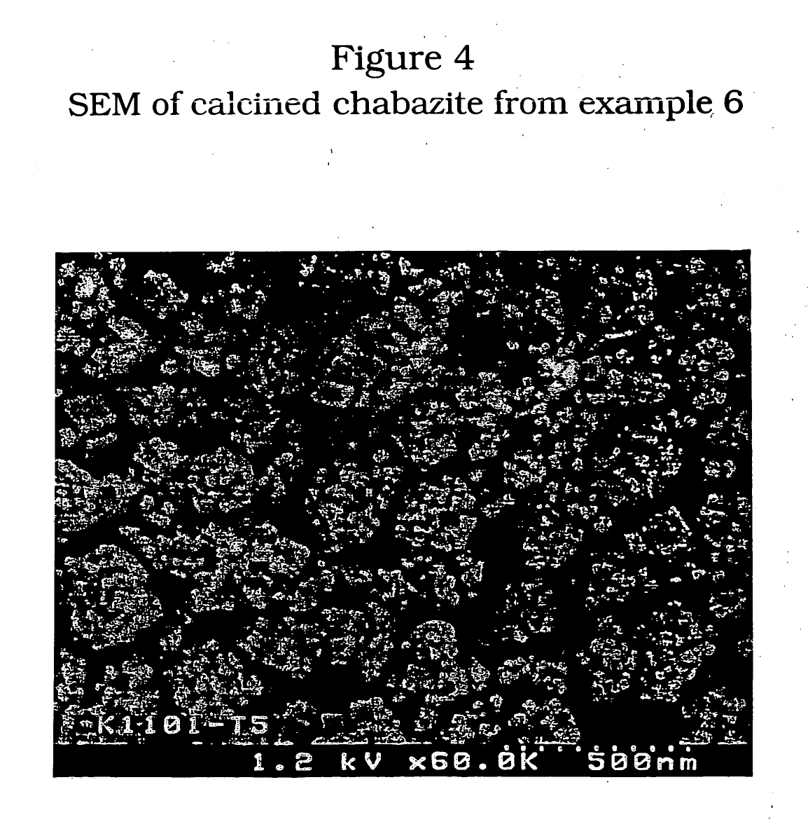

Example 6 was carried out exactly the same as Example 5 except that 130 mg LiBr were added to the reaction mixture along with the silica and water. FIG. 1 shows the product is also pure, small crystal chabazite. FIG. 2 also shows the aluminum is in the framework of the chabazite and that the Si/Al ratio is 48/1. Scanning electron microscopy shows the product to be exceptionally small crystal material. (FIG. 4).

### EXAMPLE 8

### Directing Agent Is Incorporated Intact in Zeolite

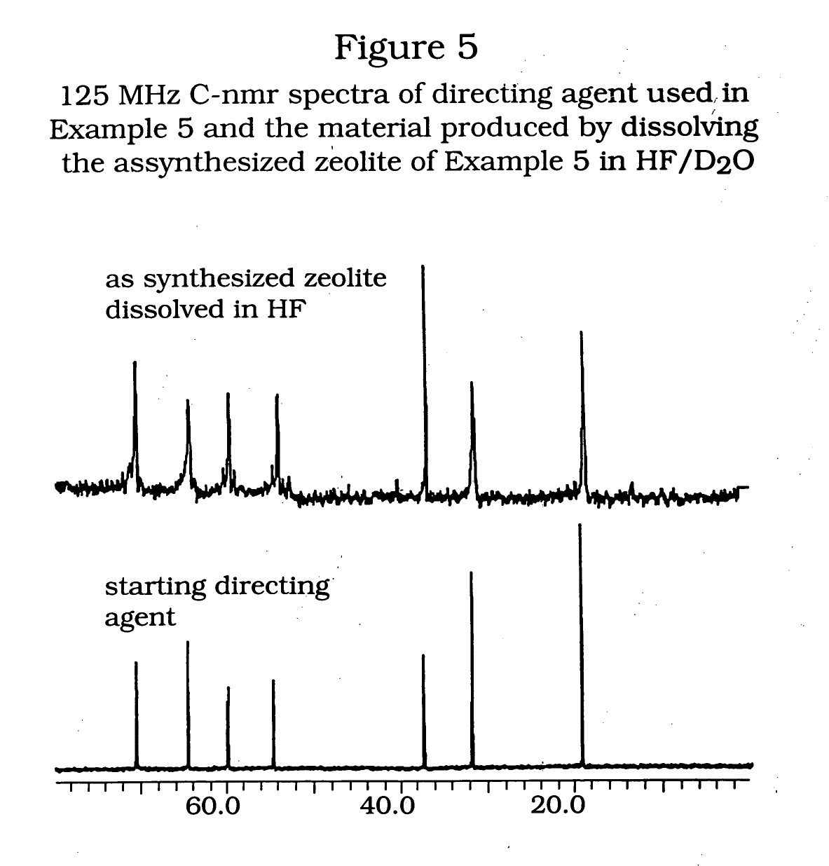

To a Teflon bottle were added in order, 48 mg of the product of Example 6 before calcination, 3.5 g 48% HF and 2.0 g D₂O. The sample dissolved instantly, consistent with the small particle size. Comparison of the C-nmr spectrum of the dissolved zeolite and the spectrum of the directing agent (product of example 4) (FIG. 5) shows the directing agent to be unchanged.

1. A composition comprising a directing agent for molecular sieves comprising two intersecting planes that intersect at an angle between 65 degrees and 115 degrees.

2. The composition of claim 1 wherein said intersecting planes are defined by two groups C1-X1(R1)(R2)-C2 and C3-X2(R3,R4)-C4 wherein X1 and X2 are nitrogen or phosphorus in the same rings as C1-C2 and C3-C4, respectively; R1-R4 may be an electron lone pair, hydrogen or aliphatic or aromatic groups, and there are sufficient R1-R4 groups to satisfy the valence of X1 and X2, and R1-R4 are not in the same rings as C1-X1-C2 and C3-X2-C4.

3. The composition of claim 1 wherein said angle is between 80 degrees and 100 degrees.

4. The composition of claim 1 wherein said angle is between 85 degrees and 95 degrees.

5. The composition of claim 1 wherein said directing agent is 2,8-diaza-spiro[5 .5]undecane.

6. The composition of claim 1 wherein said directing agent is 2,2,9,9-Tetramethyl-2,9-diazaonia-spiro[5.5]undecane.

7. The composition of claim 1 wherein said directing agent is 3,5,3′,5′-Tetramethyl-[4,4′]bipyridinyl.

8. The composition of claim 1 wherein said directing agent is 3,3′-Diisopropyl-[4,4′]bipyridinyl.

9. The composition of claim 1 wherein said directing agent is “iso”-sparteine.

10. A process for preparing crystalline molecular sieves comprising active sources of one or more oxides capable of forming crystalline molecular sieve with a directing agent including two intersecting planes that intersect at an angle between 65 degrees and 115 degrees.

11. The process of claim 10 wherein said intersecting planes are defined by two groups C1-X1(R1)(R2)-C2 and C3-X2(R3,R4)-C4 wherein X1 and X2 are nitrogen or phosphorus in the same rings as C1-C2 and C3-C4, respectively, R1-R4 may be an electron lone pair, hydrogen or aliphatic or aromatic groups, and there are sufficient R1-R4 groups to satisfy the valence of X1 and X2, and R1-R4 are not in the same rings as C1-X1-C2 and C3-X2-C4.

12. The composition of claim 10 wherein said angle is between 80 degrees and 100 degrees.

13. The composition of claim 10 wherein said angle is between 85 degrees and 95 degrees.

14. The composition of claim 10 wherein said directing agent is 2,8-diaza-spiro[5.5]undecane.

15. The composition of claim 10 wherein said directing agent is 2,2,9,9-Tetramethyl-2,9-diazaonia-spiro[5.5]undecane.

16. The composition of claim 10 wherein said directing agent is 3,5,3′,5′-Tetramethyl-[4,4′]bipyridinyl.

17. The composition of claim 10 wherein said directing agent is 3,3′-Diisopropyl-[4,4′]bipyridinyl.

18. The composition of claim 10 wherein said directing agent is “iso”-sparteine.
